(19) United States
(12) Patent Application Publication
(10) Pub. No.: US 2007/0136138 A1
(43) Pub. Date: Jun. 14, 2007

(54) System and method for analyzing network bandwidth

(75) Inventors: Gaurav Caprihan, Bangalore (KZ); Nikhil Venugopal, Secunderabad (AD)

Correspondence Address: NIXON PEABODY, LLP, 401 9TH STREET, NW, SUITE 900, WASHINGTON, DC, 20004-2128, US

(73) Assignee: Infosys Technologies, LTD, Bangalore (IN)

(21) Appl. No.: 11/298,707

(22) Filed: Dec. 12, 2005

(51) Int. Cl. G06Q 20/00

(52) U.S. Cl. 705/16

(57) ABSTRACT

The present invention relates to a system and method comprising, estimating the workload generation by an application under development at an early stage in the lifecycle. In these aspects, using actual business volume data, use case details and the screens associated with each, the present system estimates approximate bandwidth requirements required for the said application. In another aspect of the present technique, the method includes determining the actual bandwidth by a simulation model that takes into account, the random behavior of users in a client-server environment and factors in concurrency required for the bandwidth calculations. In yet another aspect of the present technique, the method includes sizing the bandwidth for determining optimal workloads in networks. In this aspect, saving, the cost reduction is concentrated with greater care, meeting the tight schedules.

### BACKGROUND OF THE INVENTION

### Field of the Invention

The invention generally relates to networking capabilities for applications, relevant with bandwidth having significant and demonstrable bearing on the matter for having large extension upward performance. In more particular aspect, the invention brings into focus bandwidth sizing estimates as part of the requirements gathering phase for budgeting and procurement.

### DISCUSSION OF THE BACKGROUND

Conventionally, the network infrastructure planning and bandwidth sizing have been largely unstructured and usually based on rules of thumb. A direct consequence has been over-estimated requirements and under utilized network resources. In present environment of shrinking IT budgets and increasing performance requirements, IT managers are not provided with sumptuous environment to arbitrarily allocate resources or sweep performance issues. “Optimal Utilization” is used in combination that is equally important in the need to integrate performance requirements into the application design as early in the life cycle as possible.

Accordingly, there is a need for a technique that has a method for estimating bandwidth requirements even before the application has been developed and IT management to start with mobilizing resources for procurement and deployment. The present system brings into focus an approach that is a systematic and structured driven by actual business volume data gathered from the business users. It arrives upon approximate values for the transactional loads hitting the system, which in turn represents the network traffic the application is expected to generate.

### SUMMARY OF THE INVENTION

The present invention comprises a system and method for analyzing network bandwidth related with use case scenarios. The system further estimates the workload genaration by the use of an application with an approach for developing the lifecycle. In these aspects, using a business volume data, use case details and screens associating accordingly, results in providing a path for estimating approximate bandwidth requirements of the application.

An alternate approach to the actual bandwidth determination is provided by way of a simulation model which takes into account the random behavior of users in a client-server environment and factors in concurrency into the bandwidth calculations.

This approach resulting to be an invaluable tool for determining optimal workloads in networks and further save costs.

In one aspect, the present invention, having multiple locations, wherein multiple users access similar web related applications, browsing over a Wide Area Network (WAN). In these aspects, to be more specific, one module comprises multiple use cases, generating and sending client requests.

In another aspect, all the requirements needed for the requests is gathered and collated into use case documents along with prototypes of the user interface. In these cases, before mobilizing resources related with the process a bandwidth requirement is needed. Hence the present system focuses to estimate the required bandwidth in the network.

In the initial aspect of the process, the use cases from the use case catalog are identified and to be more specific, with the available data the occurrence of each use case is trapped resulting into the number of times each use case have been invoked per day.

In another aspect of the process, having multiple screens associating with each case that frames the user interface, the screens are invoked each time the use case is executed. To be more sensible, the screen strings reflect the relative complexity of the screens associating with the use case. To meet its impact, depending on the screens measure the bandwidth varies. Further, classifying the screens, depending on the heaviness the screens are classified into light, medium and heavy screens. To be greater particular, further corresponding to the size of the screens dependent upon the static and the dynamic contents of the Hypertext Markup Language (HTML) page.

In specifying one particular aspect, implying the use case with n number of screens when the screen strings supplied as k,l,m. In these aspects, invoking the first screen requested by the client may be the less numbered screen string as light screen. Further, leading to the next high numbered screen string as a medium screen and further the most numbered as the heavy screen. To be very clear in this case, calculating the number of times each of the screens invoked per day by the screen count that enables further to be multiplied with the screen strings and the number of transactions of each screen.

In another aspect of calculating the bandwidth requirements, the screen count may be multiplied with the sizes assumed for either of the light or medium or heavy screens thereof. In this aspect, one case is, calculating the average bandwidth, assuming that the quantum of calculated data flows evenly across a period of day. In another case, calculating the peak bandwidth, assuming that 80% of the use case traffic flows in 20% of the total time of the system.

In one aspect relating to simulation, determining the network load, validating the results through an independent process, where the real world behavior of the network users are may be taken into account. In these situations, one condition is that comparing the generated request sizes by the client browsers from the central web server is smaller. The other condition is that, each type of request over the network experiencing a constant delay whilst traversing the whole network.

In another aspect, decomposing the database and the application server into multiple load generators, whilst corresponds to multiple use cases with fixed load size. In connecting the network, linking the source and destination and implying subtraction between these points resulting in summation point. Further, other network than the source to destination is eliminated for bandwidth estimation.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of architecture represented as a centralized web based application having the users, accessing CLMS as a distributed application with global footprint, using a browser over a corporate LAN, in accordance with an aspect of the present technique;

FIG. 2 is a screen snap shot depicting, the reflecting of screen strings for specification of the relative complexity of the screens, in accordance with an aspect of the present technique; and

FIG. 3 is a flow diagram depicting the step-wise breakdown of the various stages that are involved in the methodology of estimating the network bandwidth, in accordance with an aspect of the present technique.

### DETAILED DESCRIPTION OF THE PREFERRED EMBODIMENTS

The following description is full and informative description of the best method and system presently contemplated for carrying out the present invention which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of the user. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

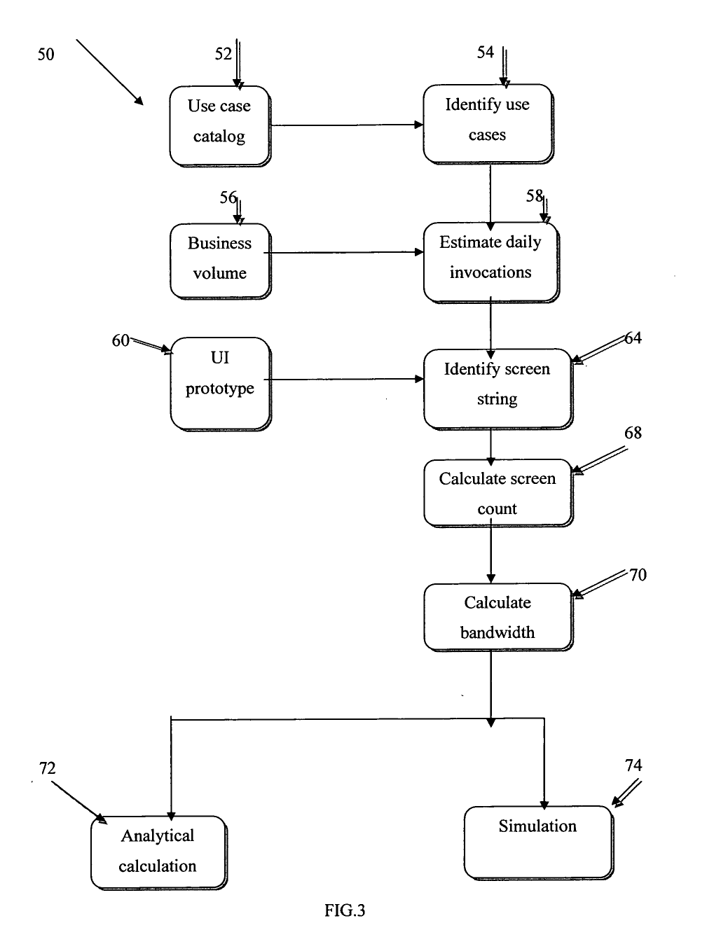

The present invention relating to the estimation of the network bandwidth, in one aspect of the present invention, as illustrates in FIG. 3, in the flow diagram depicting the step-wise breakdown of the various stages that are involved in the methodology of estimating the network bandwidth, in accordance with an aspect of the present technique. In one aspect, starting with the process is 54 from 52, and 58 that the use cases are invoked per day. In these aspects, the 56 may be depending on the actual figures gathered and assumptions validated by the business users.

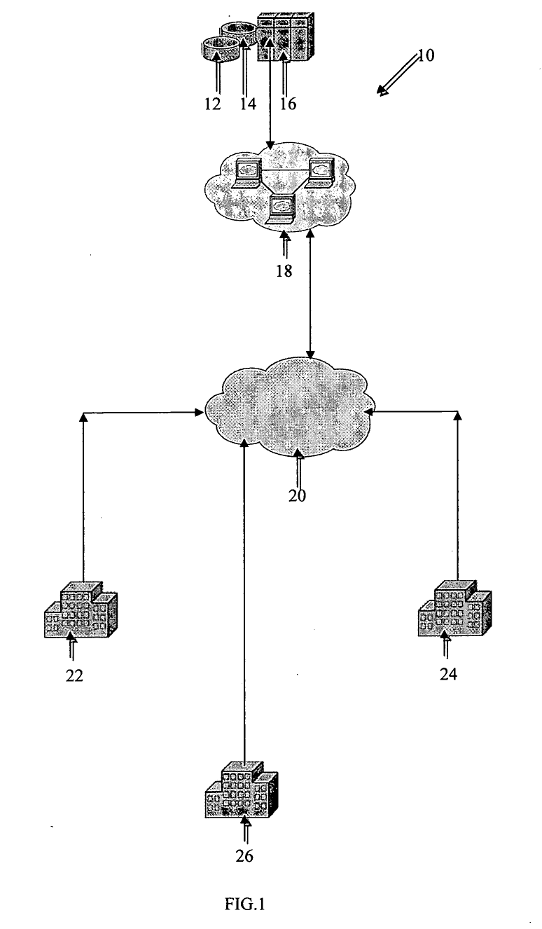

In relevant to an example, FIG. 1, depicts a block diagram of architecture 10 represented as a centralized web based application having the users, accessing CLMS as a distributed application with global footprint, using a browser over a corporate LAN, in accordance with an aspect of the present technique. As illustrated, the sample use cases from Kit Management are creating order for Kit, modification or cancellation of order and performing quality check of order. In these aspects, the number of invocations of each of the multiple use cases is based on actual volume figures and validated assumptions. In respect to the sample volume figures including, average orders for re-supply of kits received per day at each facility of LabTest:100;average size of each order in terms of line items: 5; standard operating process at lab test requires that 20% of all the kits contained within an order need to be sent for quality checks.

In order to estimate transaction volumes, modification or cancellation of order can be assumed to comprise 10% of all orders created in the system. Further, these modifications are all done on the day the orders are entered in the system viz. CLMS and before they go into fulfillment. Further, 1% of all orders entered into the system are canceled the day they are entered into CLMS. In respect to these activities, fixing a value to the number of invocations of modifying/cancel order as a function of the number of orders received per day. In respect to pointing in these cases, approximations and assumptions need to be verified by the user community.

In another aspect, the simulation of 10 is capable of not only related with a complicated affair, but resulting with also further excessive potentiality. With respect to assumptions, resulting in possibilities may be in simplification of the simulation model. Further, in relationship to one aspect, the first assumption may be in relevant to the size of the said requests generated by the client browsers in relevance to size are small in comparison to the responses from 18. In another aspect, the assumption may be that every type of request over the network experiencing a constant delay whilst traversing 10. Further, in relationship to consequence, one aspect is that the said requests themselves may be considered to be an insignificant part of the bandwidth and may be ignoring all bandwidth in relevant to calculations. In another aspect, the second assumption leading resulting that the responses generated by 12, 14 and 16 follow the same arrival pattern as the requests, offset by the constant time delay introduced by 10.

In relationship to the first assumption, one corollary is that the said data flow may be considered to be unidirectional, towards the users. Further, the said two basic assumptions, an abstract model of 18 and 20 and links in 10 may be created. In this aspect, the 12, 14 and 16 with 18 may be decomposed into a set of load generators. Further, regarding to this aspect, each generator corresponds to a distinct 32 with a fixed load size. In this aspect, the beginning of the link A-B is abstracted as a summation point (SP) that relates in the reception of the data generated by every Use-Case. In relevant to the purpose of bandwidth estimation of A-B, the rest of the network may be eliminated from the simulation.

In another aspect, further proceeding to the next section, the essentiality to relate the concept of 32 is that every request generated by a user passes through the 10 and onto the application. In this aspect, the response of the application to each request is abstracted as 32. Further, the size of the response is predetermined based on 64.

In another aspect, regarding to simulation runs, in relationship to simulating network load for client-server system, the user requests to be random in nature, and that is relevant to the Poisson process. In relationship with the second assumption, the said responses (i.e. the Use-Case generators) follow the similar said pattern. In this aspect, the mean inter-arrival time was determined from the expected number of requests for a Use-Case per day. In this aspect, the simulation testing may be in relationship with the said two sets relatively that each may be a representative load.

With respect to the deployment diagram, in this aspect the architecture referring to FIG. 1, in relationship to the client browsers, locating at the three geographically distributed 22, 24 and 26, may collectively hit 18 with page requests. In relevant to the other aspect, CLMS may be deployed in relationship resulting a distributed application, each site may have belonging to itself, 18 serves page requests for client browser sessions running at their locations specifically. Further, in relationship to the deployment diagram, forming the basis for bandwidth calculations. Further, in relationship, FIG. 1, we may specify three sites remotely accessing the centralized application, in relevant, first the width of the pipe feeding into 18 may need to be at least as thick as the bandwidth requirements of the three sites put into contact. In this aspect, the application that may be deployed is the similar said location as the central lab sites of 22, 24 and 26, including the bandwidth requirement on 20 may come down by the load capable of being attributed to the said users of first lab site because the requests of said users whereby, the application is collocated may flow over the Local Area Network (LAN) instead of over 20 as said thereof.

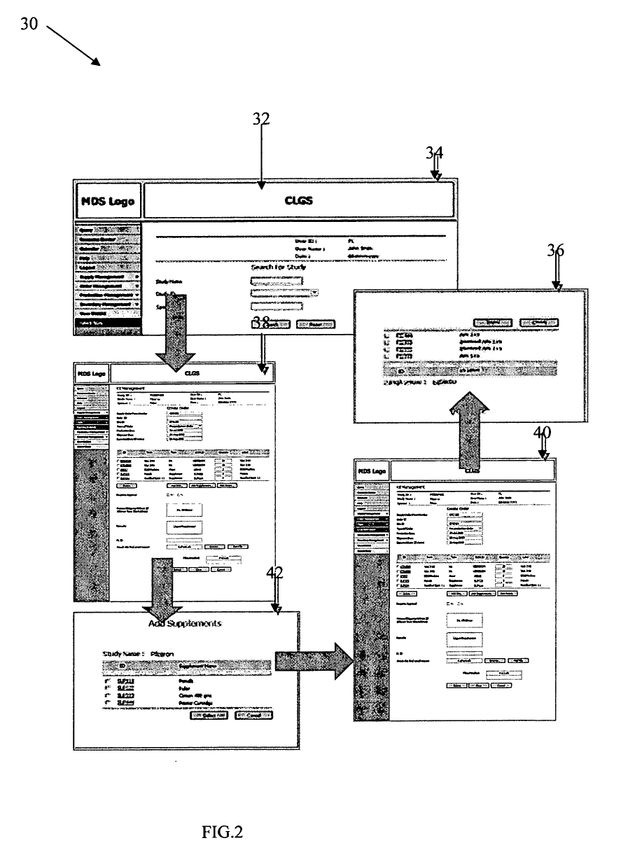

In another aspect, as illustrated in FIG. 2, is a screen snap shot depicting, the reflecting of screen strings for specification of the relative complexity of the screens, in accordance with an aspect of the present technique; identifying screen string, each 32 has a 34,36,38,40, and 42 associated with it. In respect of forming the 30, these screens, are invoked each time whenever the 32 is executed. To be relevant to the impact, 34,36,38,40 and 42 on the bandwidth depends on the “heaviness” of each screen. In respect to the classification of the screens, the screens are light 34,36 and 42, medium 38 and 40 or heavy depending upon the size of the corresponding static and dynamic content of the Hypertext Markup Language (HTML) page.

In another aspect relating to screen strings, as illustrated in FIG. 2, the said screen string is a representation of the number of light/medium/heavy screens associated with each use case. In these aspects, the said screen string for a given use case of 3, 2, 0 implies that the corresponding use case has 5 screens associated with it. To be particular on this case, three screens are light in nature and the remaining two are medium in size. With respect to the traffic, the said use case flow in 20% of the total time specifying, that 0 indicates that there are no heavy screens associated with this use case. In this respect, each time the use case is invoked the first screen to be requested by the client browser may be a light one. Further, related to these cases, this may be leading onto a medium weight screen and then another light screen and based on this respect it increases further accordingly thereof.

With respect to the rules of thumb, as illustrated in FIG. 3, these rules are used to determine the size of the screen. In respect to the 52, 56, and 60, static content or read-only grid content or very few dynamic controls/JavaScript functions (average size ≦25KB) or their combinations thereof are applied. In respect of the 54, and 58, a large number of editable grid content with embedded graphical images; number of text entry areas with multi-line input; upto ten JavaScript functions (average size between 25KB and 75KB) are applied. In respect to the heavy screen, high dynamic content with heavy graphical images; large number of complex JavaScript functions (average size >125KB) are applied.

With respect to 68, as depicted in FIG. 3, the further step in the workload modeling approach is for calculation of the number of times each of the screens of the said use case that is invoked per day. In relevant to this the said invocation of screens each time is called screen count and further in this regards, the said invocation is calculated by multiplying the entities of the screen string with the number of transactions. Further, “creation of orders for kit” is invoked 60 times per day, and it has a Screen String of 4, 1, 0 and in this case, the said screen count may be 240, 60, 0. Further, in this aspect, the screen count forming the basis for the calculation of the bandwidth is further consumed by a particular use case per day.

With respect to 70 as illustrated in FIG. 3, the said bandwidth requirements of a use case are calculated using the screen count and the sizes assumed for the light, medium and heavy screens. In respect to the assumption, a light screen may be of 25KB, medium of 75KB and heavy of 125 KB, the load imposed by “creation order for kit” with a screen count of 240, 60, 0 would be 86, 016, 000 bits. In this aspect, the volume of data flowing out of each central lab and feeding into the common pipe attached to the web server per day in relationship on account of this use case.

With respect to the average bandwidth of 70, as illustrated in FIG. 3, two approaches exist for calculating resulting in the required bandwidth for the said use case. In relationship to this aspect, the first is an optimistic approximation that is based on the assumption that the quantum of data calculated may be flowing evenly across the period of the said day. Related to these aspects, if X bits flow evenly across 24 hour interval, then the bandwidth in this approach may be calculated as X/(24*60*60). In this case, X is the size of one page or the complete size over the said day.

With respect to the peak bandwidth of 70, as illustrated in FIG. 3, the second approach may be more realistic approximation that is based upon the 80-20 rule viz. 80% of all the system is in use (24 hours). In these aspects, the bandwidth in this case comes out to be (0.8*X)/(0.2*24*60*60) bps. In one aspect, the peak to average ratio (or the burstiness of traffic) using the 80-20 rule is 4. In relationship to these aspects, the common issue for open systems that model the traffic observed on internet sites in relevant to this aspect may be the number of users hitting the system resulting may not be determined. In relevant to the other aspect, in relationship of an intranet based system (closed system), the usage of the said peak to average ratio of 2.5 to 3 can be used. To be more pertinent, the bandwidth in relationship to this aspect, the case may be (3*X)/(24*60*60).

With respect to 74 as depicted in FIG. 3, the approach in relationship is analytical technique relating to the usage the minimal and easier available information in relationship to determining a network load. In relevant to this aspect, the validating that results through an independent process is capable to the generic applicability of this methodology. In this aspect, the simulation model of the network may be developed in taking the real world behavior of the network users into account.

While, the following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What we claim is:

1. A method for estimating a network bandwidth based on a plurality of use cases, the method comprising:
identifying, the plurality of use cases from a catalog of the plurality of use cases for estimating periodicity of invocation of the plurality of use cases;
identifying, a size of a plurality of screens of the plurality of use cases resulting in classification of a light screen or a medium screen or a heavy screen;
identifying the plurality of screens of the plurality of use cases for classifying according to the size of the plurality of screens;
generating, a screen string of the plurality of use cases for representation of the light screen or the medium screen or the heavy screen;
calculating, a data volume of the plurality of use cases at a point in a course of estimating periodicity of invocation of the plurality of use cases;
estimating, the network bandwidth of the plurality of use cases and the size of the plurality of screens using the screen string; and the data volume, wherein the data volume is a calculated data volume; and
verifying, the average bandwidth and the peak bandwidth of the plurality of use cases using a simulation model.

2. The method according to claim 1, further comprising, the light screen or the medium screen or the heavy screen depending on a static content or a dynamic content of the plurality of screens, wherein the plurality of screens are Hypertext Markup Language (HTML) screens.

3. The method according to claim 1, further comprising, delaying constantly, the plurality of requests of the first side while passing through a network, wherein the network is a link forming the first side to the second side.

4. The method according to claim 1, further comprising, decomposing the plurality of use cases of an application server and a database server into a plurality of load generators, wherein the plurality of load generators resulting to the plurality of use cases with a plurality of load sizes.

5. The method according to claim 1, further comprising, eliminating the network remaining from the simulation model after receiving the plurality of data generated by the plurality of use cases for estimating the network bandwidth.

6. The method according to claim 1, further comprising, receiving the screen string of the plurality of use cases as A,B,C, and implying A+B+C of the plurality of screens of the plurality of use cases.

7. The method according to claim 1, further comprising, calculating the network bandwidth by multiplication of the screen string with a number of invocations of the plurality of use cases and the size of the plurality of screens of the plurality of use cases.

8. The method according to claim 1, further comprising invoking the plurality of screens at the point in the course of invocation of the plurality of use cases, having the plurality of use cases with the plurality of screens to form into a user interface.

9. The method according to claim 2, wherein the light screen ranging the size less than or equal to K, ranging the size of the medium screen between L and M, and ranging the size of the heavy screen greater than or equal to N.

10. The method according to claim 3, further comprising, receiving a plurality of generated data by the plurality of use cases, from the first side to the second side of the network for estimating the network bandwidth, at a summation point.

11. The method according to claim 4, further comprising, having independently, the application server in relationship with the first side, wherein simultaneously sending from the first side a plurality of requests to the application server.

12. The method according to claim 6, wherein a screen string A, a screen string B, a screen string C is multiplied with the size of the plurality of screens of the plurality of use cases resulting in a resultant bandwidth as A*K+B*(L to M)+C*N.

13. The method according to claim 6, further comprising reception of the plurality of screens comprising the light screen or the medium screen or the heavy screen depending on the indication of the screen string.

14. The method according to claim 7, further comprising, calculating the average bandwidth with a first approach, wherein, x relating to a plurality of total data flowing through a pipe during a day.

15. The method according to claim 7, further comprising, calculating the peak bandwidth with a second approach, wherein, y relating to the plurality of total data flowing though the pipe during the day.

16. The method according to claim 11, further comprising, feeding into the application sever, sizing the pipe to a sum of all requirements of the network bandwidth.

17. A system adapted for estimating a network bandwidth on a plurality of use cases, the system comprising:
a catalog for identification of the plurality of use cases and estimating periodicity of invocation of the plurality of use cases;
a triad adapted for denoting a number of a plurality of screens at a point in the course of invocation of the plurality of use cases;
a screen adapted for classification according to the size of the plurality of screens;
a screen string adapted for representation of a light screen, or a medium screen or a heavy screen;
a data volume adapted for calculation of estimating periodicity of invocation of the plurality of use cases;
a simulation tool adapted for calculation of an average bandwidth and a peak bandwidth; and
a user interface adapted for traversing the screen wherein, the screen is invoked by the plurality of use cases.

18. The system according to claim 17, an application server in combination with a database server both adapted for decomposing the plurality of use cases into a plurality of load generators, wherein the plurality of load generators resulting to the plurality of use cases with a plurality of load sizes.

19. The system according to claim 17, a network link adapted for connecting a first side with a plurality of locations to a second side, wherein the first side simultaneously sending a plurality of requests to the second side of the network.

20. The system according to claim 17, wherein the data volume resulting into the database server with collection of a data in relationship with the plurality of the use cases of a plurality of locations.

21. A computer program product tangibly embodying a plurality of instructions for analyzing a network bandwidth estimation on a plurality of use cases, comprising:
program code adapted for calculation of the network bandwidth by multiplication of a screen string with a number of invocations of the plurality of use cases and a size of the plurality of screens of the plurality of use cases; and
program code adapted for calculating an average bandwidth and a peak bandwidth of the plurality of use cases using a simulation model.

22. The computer program product according to claim 21, further comprising program code adapted for calculating the average bandwidth with a first approach, wherein x relates to a plurality of total data flowing through a pipe during a day.

23. The computer program product according to claim 21, further comprising program code adapted for calculating the peak bandwidth with a second approach, wherein y relates to the plurality of total data flowing though the pipe during the day.

24. The computer program product according to claim 21, further comprising, having independently, an application server in relationship with a first side, wherein simultaneously sending from the first side a plurality of requests to the application server.

25. The computer program product according to claim 21, further comprising, decomposing a first database component and a second application server component into a plurality of load generators, wherein the plurality of load generators corresponding to the plurality of use cases.

26. The computer program product according to claim 21, further comprising, eliminating the network remaining from the simulation model after receiving the plurality of data generated by the plurality of use cases for estimating the network bandwidth.

27. The computer program product according to claim 21, further comprising, reception of a plurality of generated data by the plurality of use cases, from the first side to the second side of the network for estimating the network bandwidth, at a summation point.

28. The computer program product according to claim 21, further comprising, feeding into the application sever, sizing the pipe to a sum of all requirements of the network bandwidth.
